(19) United States
(12) Patent Application Publication
(10) Pub. No.: US 2024/0208167 A1
(43) Pub. Date: Jun. 27, 2024

(54) OPTICAL FIBER CONNECTOR AND PRODUCTION METHOD THEREOF

(71) Applicant: Hella GmbH & Co. KGaA, Lippstadt (DE)

(72) Inventors: David Allouis, Bad Iburg (DE); Ana Bizal, Domzale (SI); Jürgen Griebel, Steinen (DE); Robin Hofner, Heilbronn (DE); Vinzenz Sandfort, Zell im Wiesenthal (DE); Heiko Schöne, Zell im Wiesenta (DE); Roland Schwarz, Todtnau (DE)

(21) Appl. No.: 18/595,966

(22) Filed: Mar. 5, 2024

Related U.S. Application Data
(63) Continuation of application No. PCT/EP22/73454, filed on Aug. 23, 2022.

(30) Foreign Application Priority Data
Sep. 8, 2021 (DE) 10 2021 123 276.7

(51) Int. Cl. B29D 11/00

(52) U.S. Cl. CPC B29D 11/0075; G02B 6/0006

(57) ABSTRACT

An optical fiber has an individual fiber and a sheath. The sheath on one end is stripped, such that a length of at least one end of the individual fiber is exposed. An injection mold has a first part first part that contains a first cavity into which an injection molding material is injected. A second part of the mold contains a second cavity in which at least one end of the optical fiber is placed. The end of the optical fiber is secured in the second cavity. A second length of the exposed end of the fiber extends into the first cavity. The injection molding material is injected into the first cavity to obtain a connector element. The at least one exposed end of the optical fiber is at least partially coated. The first part and second part of the mold are brought to different temperatures.

### CROSS REFERENCE

This application claims priority to PCT Application No. PCT/EP2022/073454, filed Aug. 23, 2022, which itself claims priority to German Application No. 10 2021 123276.7, filed Sep. 8, 2021, the entireties of both of which are hereby incorporated by reference.

### FIELD OF THE INVENTION

The invention relates to a method for the production of an optical fiber connector on an optical fiber composed of at least one fiber and one sheath. The sheath is removed at one end of the optical fiber, such that at least a predefined length of the end of the at least one fiber is exposed. An injection mold comprising two parts is used, the first of which has a first cavity into which the injection molding material is injected, and the second part has a second cavity in which the end of the optical fiber is placed. The end of the optical fiber is secured in place in the second cavity and a second length of this exposed end extends into the first cavity. The injection molding material in the first cavity forms a connector element that coats at least part of the exposed end of the optical fiber.

The invention also relates to an optical fiber connector and a lighting system.

### BACKGROUND OF THE INVENTION

LED lights and optical fibers are used in ambient lighting systems in vehicles, for example, in order to comply with current demands regarding energy consumption and weight. In addition to white LEDs, brighter multi-colored LEDs (RGB-LEDs) are also used, with which the color of the light can be modified. These LEDs are normally placed on a semiconductor chip. To obtain a homogenous light distribution, the beams of each light source are conducted through an optical mixer.

There are a variety of means and methods with which light is guided into the optical fiber. Of central importance is a high level of efficiency when guiding the light therein, a compact structure, and the generation of homogenous light, without colored edges or shadows.

To conduct light from the light source to an object that is to be illuminated, the optical fiber is composed of numerous individual fibers and a sheath. The ends of these fibers are reinforced and optically optimized.

Sleaves are used in the prior art to hold the fibers together, that are pulled over them and them crimped. The pressure applied to the ends has a negative impact on light conductance. It is also possible to use sleaves that, instead of crimping, are glued to the fibers using an adhesive with optical properties coordinated to those of the fibers. Adhesive can also be used in addition to the crimping.

One disadvantage therewith is that the process is prone to error, and difficult to monitor, due to the tolerances that must be maintained. This leads to an increase in rejects, and higher production costs, because additional production steps are necessary.

DE 102 00 195 A1 discloses coating the exposed ends of the optical fibers in a bundle with plastic. The plastic housing obtained by coating the individual fibers can be modified in the injection molding process to meet predefined specifications.

An injection molding framework made of a transparent or opaque plastic is disclosed in DE 2014 218 752 A1, in which the ends of numerous optical fibers are embedded using an injection molding process. The injection molding framework is placed in front of the at least one LED such that the light therefrom enters the individual fibers. This unfortunately means that either multi-colored light cannot be used, or an optical mixer must be placed between a multi-colored light source and the injection molding framework. Another disadvantage with this is that the fibers must be cut off and polished in an additional step, in order to obtain a higher optical efficiency.

### BRIEF SUMMARY OF THE INVENTION

The object of the present invention is therefore to create an optical fiber connector, a lighting system, and a method for the production of the optical fiber connector that is particularly simple, quick, and inexpensive, as well as resulting in a strong and durable bond.

An optical fiber is understood to be an optical waveguide containing a least one individual fiber or numerous individual fibers (forming a bundle). The at least one fiber is in a sheath, which is stripped at one end in order to connect it. This exposes a segment of the at least one fiber.

The light source in the context of the invention is formed by a light emitting diode (LED) or numerous light emitting diodes. These can be light emitting diodes that emit white light as well as light emitting diodes that emit colored light (RGB-LEDs).

A segment L₁ of the optical fiber that is not sheathed is the length of the fiber from which the insulation has been stripped. The length L₂ is part of the length L₁ from which the sheath has been stripped, i.e. exposed, that extends into the first cavity and is coated with injection molding material.

The connector element is placed between the light source and the optical fiber. It has a light entry surface through which the light emitted from the light source enters, and conducts the light through total internal reflection toward the optical fiber, such that the light is reliably conducted from the LED into the optical fiber.

Because the two parts of the mold are brought to different temperatures, the end of the at least one fiber placed therein is partially melted, while the exposed parts of the ends extending toward the second cavity maintain their shape. Because a second length L₂ of the exposed end of the fiber extends into the first cavity and is at least partially coated with the injection molding material, the connector element can advantageously be made of the same material as the optical fiber. Because the ends of the fibers are already melted by the heating process, they become liquified when the injection molding material is injected into the first cavity, resulting in a material bonding thereof. There is no need for any post-processing of the ends of the fibers. This results in a mechanically sturdy bond between the connector element and the optical fiber, and an improved conductance of the light into the optical fiber. This advantageously results in a single component that can be easily produced, which forms a durable and strong optical fiber unit. As a result of the structural durability obtained with the method according to the invention, the connector element is durable enough to be incorporated in a housing.

There is also the advantage that the ends of the fibers do not require any post-processing steps, because the ends do not need to be cut off or polished. By eliminating these processing steps, which take time and are expensive, the ends also do not become damaged or contaminated. Because the ends of the fibers do not become contaminated, better optical properties are obtained.

It is advantageous to heat the first part of the mold to a predefined temperature while bringing the second part of the mold to a predefined temperature that is lower than the temperature the first part is heated to. Because the one temperature is colder than the other, the liquid injection molding material is unable to flow around the part of the fiber ends in the second part of the mold and the bridge element, because the injection molding material hardens therein. Consequently, the optical properties of the individual fibers are maintained, because none of the injection molding material is able to flow between the individual fibers in the bundle.

In a preferred embodiment of the invention, heating temperature and/or the cooling temperature are set by a control unit on the basis of the injection molding material that is used. Because the melting behavior, or flow properties, of the injection molding material, preferably a thermoplastic material, depends on what material is selected, the temperatures are set such that the desired behavior is obtained. This can further improve the optical properties where light enters the optical fiber.

Ideally, the two parts of the injection mold are thermally insulated from one another. This results in the advantage that the injection molding material hardens as soon as the temperature is no longer hot enough to liquify the material. This thermal insulation prevents any heat exchange, such that the region where the injection molding material hardens can be defined.

In one advantageous embodiment of the invention, the at least one exposed individual fiber extends from the second part of the mold into the first part of the mold through a bridge element that is in the same plane as the first and second parts of the mold. This forms the thermal insulation between the two parts of the mold. It is particularly advantageous to line the inner surfaces of the bridge element. This lining can be glued to the side thereof facing the at least one exposed individual fiber, or the inner walls of the bridge element can be coated such that a lining is obtained. Because the bridge element is in the same plane as the parts of the mold, the connection between the connector element and the optical fiber follows a straight line, thus maintaining the optical properties of the individual fibers.

It is advantageous if the first part of the mold has at least one structure that forms a heating channel for a first liquid and/or the second part of the mold has at least one structure that forms a cooling channel for a second liquid. Consequently, liquids of different temperatures can flow through the separate channel structures, in order to obtain different temperatures in the two parts of the mold.

In a preferred embodiment of the invention, the connector element is integrally joined to at least one latching element that secures it in a housing. This results in a means for securing the connector element in place that can be tailored individually to a housing according to customer specifications. The connector element is inserted in the housing, and the optical fiber connected thereto can remain flexible. This results in a predefined fit obtained during the production process, such that the connector element can be placed in a light entry component or housing according to customer specifications. There is no need for an additional component, thus reducing weight and size. With the latching element, the optical fiber connector assumes not only the function of conducting the light, but also functions as a retention element. The optical fiber can therefore be connected to the housing for a lighting device without any additional steps.

In an advantageous embodiment of the invention, the connector element forms an injection molded optical mixer. This mixes the light from a multi-colored light source to obtain a homogenous, uniform light distribution in the optical fiber, without the need for an additional component. The intensity and color of the multi-colored light source remain intact without substantial losses. This results in a space-saving, lightweight assembly, with which the light is not only conducted into the optical fiber, but is also thoroughly mixed therein. The embodiment with a light mixer results in a particularly advantageous and high level of efficiency, because the fibers in the optical fiber are materially bonded to the connector element, resulting in direct contact with the optical fiber.

The advantages of the optical fiber connector and the lighting system correspond to the advantages specified above with regard to the method according to the invention for production of the optical fiber connector.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows an injection mold,

FIG. 2 shows an injection mold with an optical fiber placed therein.

FIG. 3A shows an injection mold with an injection molded connector element.

FIG. 3B shows an optical fiber connector.

FIG. 4 shows another optical fiber connector.

FIG. 5 shows a lighting system.

FIG. 6 shows the steps of the method.

### DETAILED DESCRIPTION OF THE DRAWINGS

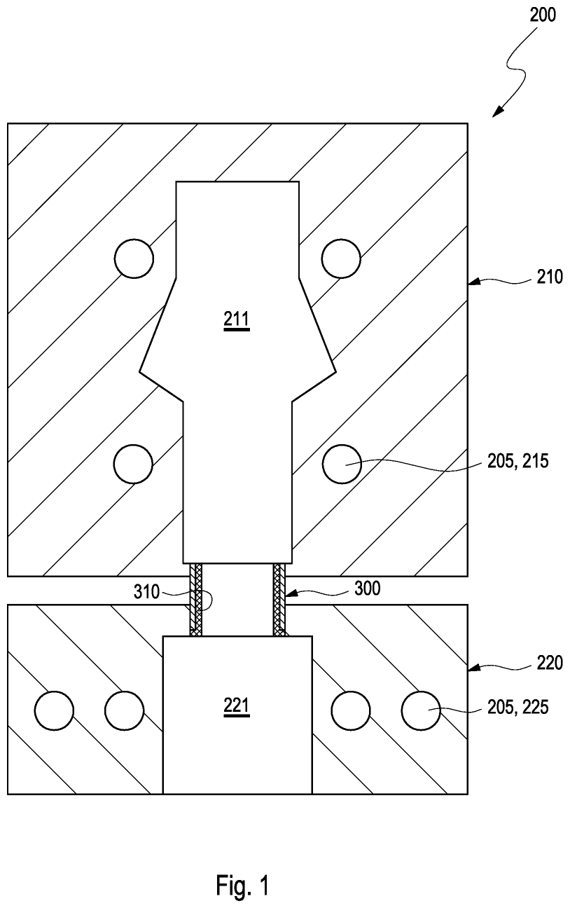

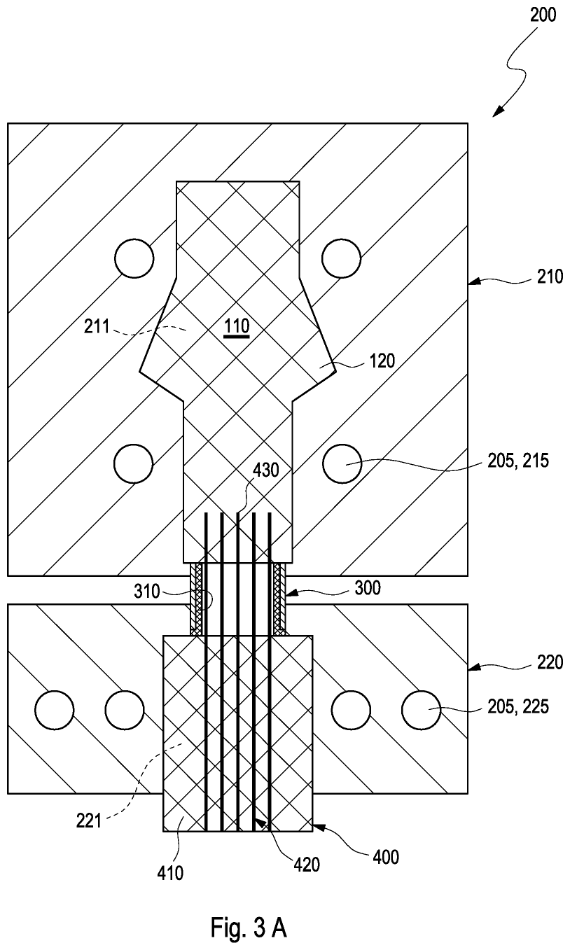

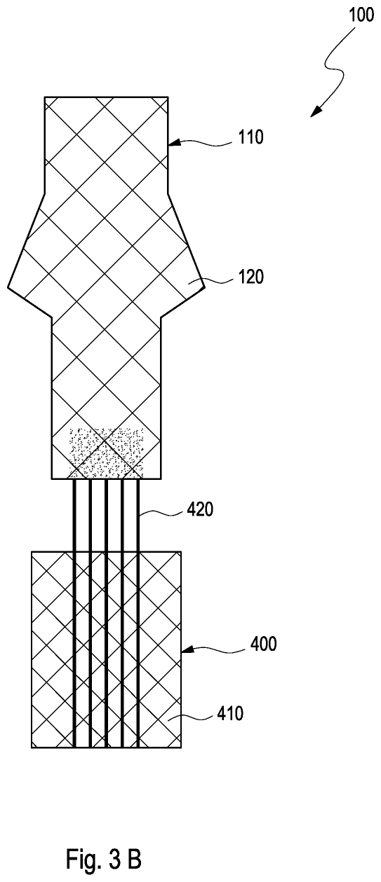

FIG. 1 shows an injection mold 200, with which an optical fiber connector 100, shown in FIG. 3B, is produced using the method according to the invention. The injection mold 200 comprises a first part 210 that contains a first cavity 211, and a second part 220 that contains a second cavity 221. The two solid parts 210, 220 contain structures 205 forming channels through them. The structure 205 in the first part 210 is a heating channel through which a first liquid flows at a predefined temperature T. The structure 205 in the second part 220 is a cooling channel 225 through which a second fluid flows through the second part 220. The structures 205 for both channels 215, 225 are continuous, and have an intake and outlet for the respective liquids, thus forming a closed circuit in each case. The temperature of the second liquid, the cooling temperature T_{K} is lower than the predefined temperature T of the first liquid. A thermal insulation is placed between the two parts 210, 220, which prevents heat exchange between them. The two parts 210, 220 can also be formed by two separate molds in order to obtain the thermal insulation. The parts 210, 220 are connected by a bridge element 300. This bridge element 300 is lined or coated with a lining 310 on its inner walls.

The shapes of the cavities 211, 221 in FIG. 1 are merely shown by way of example. In particular, the first cavity 211 can have an arbitrary shape that is necessary for the production of the optical fiber connector element 110. The first cavity 211 is for the injection molding material, and an end E of the optical fiber 400 is placed in the second cavity 221, as shall be explained below.

In a first step 510 of the method, the two parts 210, 220 of the mold are brought to their respective temperatures. What is important here is that the temperature drops from the first part 210, in the cavity 211 of which the injection molding material is injected, to the second part 220. The drop in temperature depends on the material that is used. The injection molding material that is injected into the first cavity 211 can be plastic. A thermoplastic material such as PC or PMMA is preferably used. If PMMA (poly(methyl methacrylate)) is used as the injection molding material, the first liquid, preferably water, is heated to a temperature T of 60° C. to 80° C. in the heating channel 215 in the first part 210 of the mold. The second fluid, also preferably water, is conducted through the cooling channel 225 in the second part 220 of the mold at a temperature T_{K} of 30° C. to 40° C. in this exemplary embodiment. This results in the necessary temperature drop. The temperatures are set and monitored by a control unit. If PC (polycarbonate) is used as the injection molding material for the production of the optical fiber connector 100, the liquid in the first part 210 of the mold flows through the heating channel 225 at a temperature T of 90° C. to 120° C., and the second liquid flows through the cooling channel 225 in the second part 220 of the mold at a temperature of 50° C. to 70° C. The temperature of the injection mold 200 is also controlled here by a control unit in accordance with the injection molding material that is used. The process also be temperature controlled. Sensors are used for this, that are connected to the control unit. Devices such as pumps are connected to the intakes and outlets of the channels, which are also connected to the control unit.

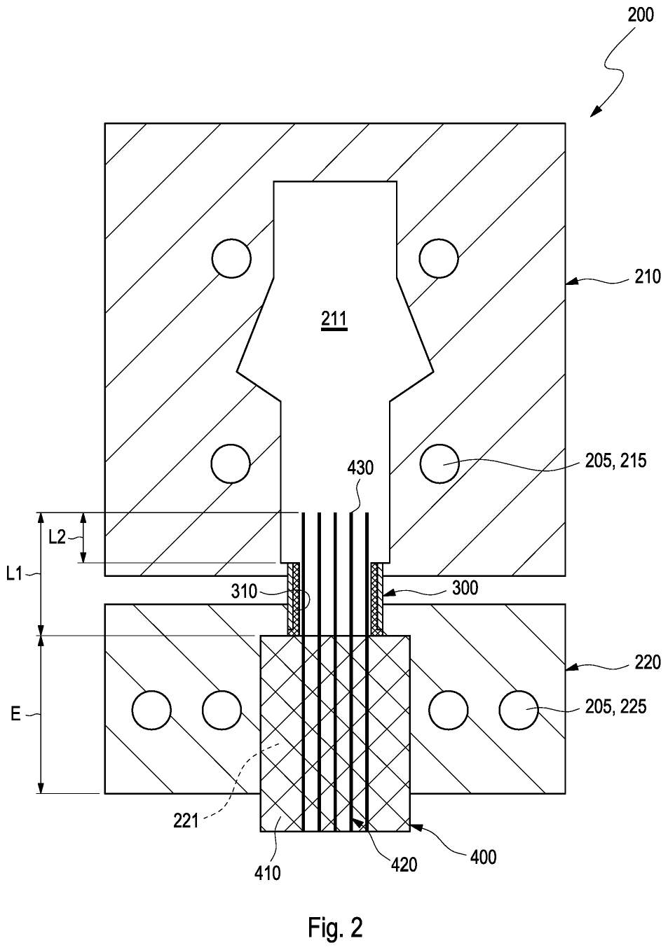

FIG. 2 shows an end E of the optical fiber 400 already placed in the second cavity 221 in the injection mold 200, with its at least one individual fiber 420 and a sheath 410. A segment of the sheath 410 on the end of the optical fiber 400 is removed prior to placing it in the second cavity 221. This exposes a length L₁ of the end 430 of the at least one fiber forming the optical fiber 400. The optical fiber 400 comprises numerous individual fibers 420 that form a bundle in the sheath 410. The optical fiber 400 can be a single fiber or a bundle of fibers. The end E of the optical fiber 400 is placed in the mold 200 such that a segment of the optical fiber 400 is secured with its sheath 410 in the second cavity 211 in the second part 220 of the mold, and a length L₂ of the exposed ends 430 of the fibers passing through the bridge element 300 extends into the first cavity 211. The bridge element 300 therefore forms a connection between the two thermally insulated parts 210, 220 of the mold. Because the second length L₂ is shorter than the length L₁ of the exposed ends of the fibers, the at least one individual fiber 420 has a certain stiffness in the first cavity 211. This results in a stable positioning of the stripped end 430 of the fiber in the first cavity 211. Because the exposed ends 430 of the fibers are optically and mechanically fragile, a lining 310 is placed in the bridge element 300 to protect the part of the at least one exposed individual fiber 420 therein. The lining 310 can be made of an elastic material such as EPDM (ethylene propylene diene monomer) rubber, PUR (polyurethane), silicone, TPE (thermoplastic elastomer), etc. Gluing or coating the elastic material to the surface of the bridge element 300 facing the ends of the of the optical fiber 400 results in sufficient protection against contaminating or scratching the exposed ends 430 of the fibers.

If the inner walls of the bridge element 300 are coated, the lining 310 remains in the injection mold 200 after completing the injection molding process, and can be reused, thus further reducing costs. The lining 310 can also form a collar that extends into the first cavity 211 and is then coated with the injection molding material to form a part of the finished optical fiber connector 100. When the optical fiber connector 100 is then removed from the injection mold 200, the lining 310 remains on the connector element 110 to protect the exposed individual fibers 420.

After completing the second step 520, securing the end E of the optical fiber 400 in the second cavity 221, the third step 530 is started, see FIG. 3A. When the individual parts are assembled, the injection mold 200 forms a first cavity 211 that can be filled with an injection molding material. The injection molding material injected into the first cavity 211 can be a thermoplastic material, preferably PC or PMMA. The first part 210 of the mold is already heated to the predefined temperature T in this step 530. Heating the first part 210 of the mold has a positive effect on the flow behavior of the plastic, because it hardens more slowly. At the same time, the heating melts the end 430 of the at least one fiber, part of which is in the first cavity 211. When the injection molding material is injected, the molten length L₂ of these ends 430 forms a material bond with the injection molding compound, which cools to form the connector element 110. Because the length L₂ is relatively short, the ends melt and bond quickly to the injection molding material, and the individual fibers 420 in the bundle remain stiff and do not move when the injection molding material is injected. If the injection molding material is the same material used to form the optical fibers, a precision component is produced that satisfies the highest optical specifications.

Because the second part 220 of the mold is also already at the cooling temperature T_{K}, which is lower than the predefined temperature T in the first part 210 of the mold, the injection molding material solidifies at the bridge element 300 and does not flow into the second cavity 221. The injection molding material is immediately cooled, solidifies, and hardens nears the bridge element 300. By controlling the temperatures of the parts 210, 220 of the mold, the slow hardening has a positive effect on the properties and quality of the optical fiber connector 100 that is produced.

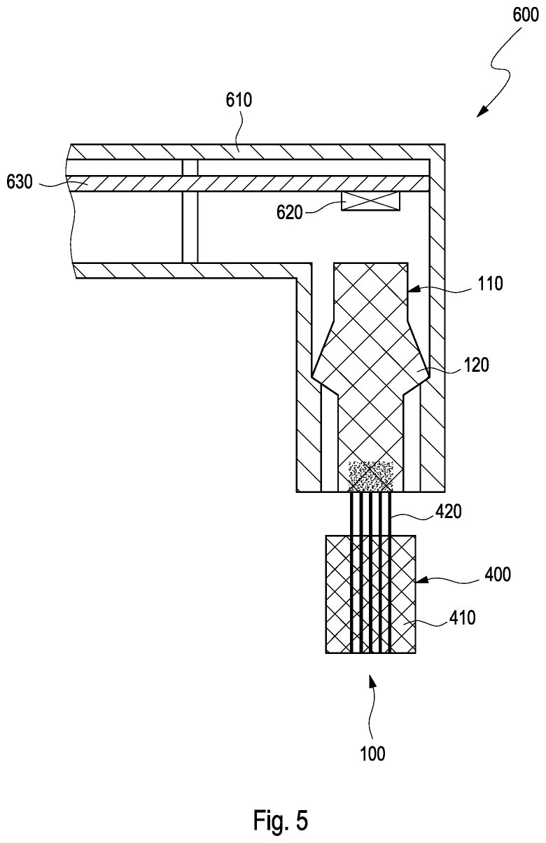

The optical fiber connector 100 with the injection molded part forming the cylindrical connector element 110 in this case, is shown in FIG. 3B. The optical fiber connector 100 in this exemplary embodiment also contains numerous individual fibers 420 that are contained in the sheath 410 for the optical fiber 400, and bonded at their ends 430 to the connector element 110 in the injection molding process, indicated here by the grey region. Latching elements 120 are formed on the connector element 110 in this exemplary embodiment during the injection molding process, which engage with a housing 610 for a lighting system 600, as shown in FIG. 5.

Another embodiment of the optical fiber connector 100 contains the lining 310 for the bridge element 300, which is applied to the connector element 110 in the injection molding process, not shown here. As explained above, the lining 310 protects the exposed fibers 420 with regard to their mechanical and optical properties.

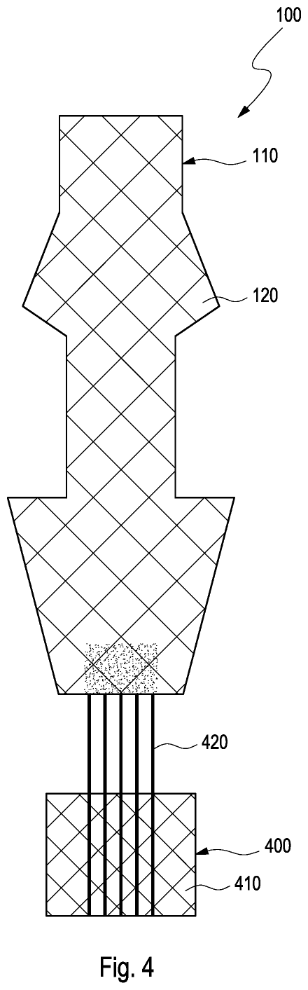

FIG. 4 shows a preferred embodiment of the optical fiber connector 100. An optical mixer forms an integral extension of the connector element 110. Because color homogeneity must be ensured when RGB-LEDs are used as the light source 620, which is not the case with white LEDs, the light first passes through a type of optical mixing chamber, and then enters the optical fiber 400. In this exemplary embodiment, the connector element 110 and the optical mixer form a single part made of a solid material such as PMMA or PC in the injection molding process, in which the light from the RGB-LEDs is fully mixed when it enters the optical fiber 400. In this exemplary embodiment, the ends of the fibers are bonded to the injection molded material in the optical mixer. The optical mixer can have a variety of cross sections, e.g. round, square, or rectangular. A section of the connector element 110 has a polygonal cross section in this exemplary embodiment, which has at least four sides, preferably five, and particularly preferably six sides, which mixes the multi-colored light from the light sources homogenously, before it enters the fibers forming the optical fiber 400. The cavity 211 in the first part 210 of the mold has the same shape, and the connector element 110 is injection molded with the optical mixer, which has an arbitrary shape, e.g. a truncated cone, or truncated pyramid.

A lighting system 600 is shown in FIG. 5. The lighting system 600 comprises a housing 610 with a light source 620 and the optical fiber connector 100 dedicated to the light source 620. A printed circuit board 630 can be placed in the housing 610, which is connected to an electrical power source in the vehicle. The light source 620 on the printed circuit board 630, or a semiconductor chip, emits white, colored, or multi-colored light. It can be an LED or an RGB-LED, depending on the intended use. The light source 620 comprises one or more LED units for this. The respective LED units each have dedicated optical fibers 400 that conduct the light from the light source 620. The end of the connector element 110 lying opposite the respective light source 620 has a light entry surface for this. The light from the light source enters the connector element 110 through this light entry surface, and thus enters the optical fiber 400. The light enters the end of the adjacent or dedicated connector element 110, is mixed homogenously in the embodiment with an optical mixer, and conducted to the object that is to be illuminated by the at least one individual fiber 420. Total internal reflection takes place within the connector element 110, which continues in the subsequent optical fiber 400. Because the ends 430 of the fibers in the send length L₂, indicated by the grey region here, are bonded to the connector element 110, the light from the light source 620 enters the optical fiber 400 here. This results in an efficient light conductance in the optical fiber 400, i.e. without any interference. Appealing lighting effects can be generated with this lighting system 600, in particular for lighting the interior of a motor vehicle. The coupling element 110 is secured in place in the housing 610 by its at least one latching element 120.

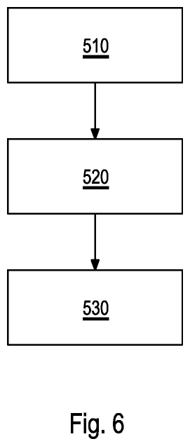

FIG. 6 shows the individual steps of the method in a simplified block diagram. In a first step 510, an optical fiber 400 is provided, the sheath 410 of which is removed at one end. The processed optical fiber 400 has the sheath 410 on its end E, from which the exposed ends 430 of the fibers extend a certain length L₁. An injection mold 200 is also provided, which is composed of two parts 210, 220, that are brought to different temperatures, and are thermally insulated from one another. In a second step 520, the end E of the optical fiber is placed, or secured, with the sheath 410 in the second cavity 221 such that a segment, the second length L₂,of the stripped ends 430 of the fibers, i.e. the at least one exposed individual fiber, extends into the first cavity 211 in the first part 210 of the mold, and is melted therein. In the third step 530, the injection molding material n is injected into the first cavity 211, in which a second length L₂ of the ends 430 of the fibers, which is shorter than the first length L₁, is bonded to the injection molding material. The ends 430 of the fibers are melted together over their second length L₂, if there are numerous ends 430 of fibers, and melted with the connector element 110 to form a compound, such that there are no more empty spaces. This melting results in a maximum light entry into the optical fiber 400. Because the second part 220 of the mold is at the cooling temperature T_{K}, the injection molding material does not flow through the bridge element 300 between the individual fibers 420. The individual fibers 420 maintain their shape. Upon completing the injection molding process, the temperature is adjusted such that the injection molding material hardens, and the optical fiber connector 100 can be removed from the injection mold 200.

### LIST OF REFERENCE SYMBOLS

100 optical fiber connector
110 connector element
120 latching element
200 injection mold
205 structure
210 first part of the mold
211 first cavity
215 heating channel
220 second part of the mold
221 second cavity
225 cooling channel
300 bridge element
310 lining
400 optical fiber
410 sheath
420 individual fibers
430 ends of fibers
510 first step of the process
520 second step of the process
530 third step of the process
600 lighting system
610 housing
620 light source
630 printed circuit board
L₁ first length
L₂ second length
E end
T temperature cooling temperature
T_{K}

1. A method for production of an optical fiber connector, the method comprising the following steps:
providing an optical fiber, which contains at least one individual fiber, and a sheath;
stripping the sheath on one end of the optical fiber, such that a predefined first length (L₁) of at least one end of at least one individual fiber is exposed;
providing an injection mold that has a first part and a second part, wherein the first part has a first cavity into which the injection molding material is injected, and the second part has a second cavity in which at least an end (E) of the optical fiber is placed;
securing the end (E) of the optical fiber in the second cavity, wherein a second length (L₂) of the at least one exposed end extends into the first cavity;
injecting the injection molding material into the first cavity to obtain a connector element, wherein the at least one exposed end of the optical fiber is at least partially coated with the injection molding material,
wherein the first part and second part of the mold are brought to different temperatures.

2. The method according to claim 1, wherein the first part of the mold is heated to a predefined temperature (T), and the second part of the mold is brought to a predefined cooling temperature (T_{K}), which is lower than the predefined temperature (T) for the first part of the mold.

3. The method according to claim 2, wherein the predefined temperature (T) and/or the cooling temperature (T_{K}) are set by a control unit according to specifications for the injection molding material that is used.

4. The method according to claim 1, wherein the first part of the mold is thermally insulated from the second part.

5. The method according to claim 1, wherein the at least one exposed individual fiber extends from the second part of the mold through a bridge element into the first part of the mold, wherein the bridge element is in the same plane as the first part and second part of the mold.

6. The method according to claim 5, wherein the bridge element has a lining on the side facing the at least one exposed individual fiber.

7. The method according to claim 1, wherein the first part of the mold has at least one structure which forms a heating channel for a first liquid, and/or the second part of the mold has at least one structure that forms a cooling channel for a second liquid.

8. The method according to claim 1, wherein the connector element is injection molded with an integral latching element with which it is secured in a housing.

9. The method according to claim 1, wherein the connector element forms an optical mixer.

10. An optical fiber connector through which light from a light source enters, the optical fiber comprising:
at least one connector element, and
at least one optical fiber which has at least one individual fiber with a stripped end,
wherein the connector element is produced in an injection molding process, and materially bonded to the at least one stripped end of the optical fiber.

11. A lighting system comprising:
a housing in which the at least one light source and an optical fiber connector according to claim 10 are located, wherein the optical fiber connector is dedicated to the at least one light source.

12. The lighting system according to claim 11, wherein the light source is an RGB-LED, and the connector element is an optical mixer.
